(19) United States
(12) Patent Application Publication
(10) Pub. No.: US 2003/0184821 A1
(43) Pub. Date: Oct. 2, 2003

(54) Carriage guide structure for image-reading device

(76) Inventor: Eiichi Hayashi, Saitama City (JP)

Correspondence Address: Arnold International, P.O. Box 129, Great Falls, VA, 22066, US

(21) Appl. No.: 10/367,335

(22) Filed: Feb. 19, 2003

(30) Foreign Application Priority Data
Mar. 29, 2002 (JP) 2002-096757

(51) Int. Cl. H04N 1/04

(52) U.S. Cl. 358/498; 358/474

(57) ABSTRACT

A carriage guide structure for an image-reading device that includes an optical unit, a light source, and a photoelectric conversion device on a carriage that is movable to scan a document placed on the image-reading device in order to sequentially read data from the document is disclosed. The carriage guide structure includes a casing for housing the carriage. The carriage is supported in the casing by guide rods, a guide rod and a roller or rollers, or, alternatively, only by rollers. A roller on one side portion, or on both side portions, of the carriage may engage a bottom plate or one or both sides of the casing to guide the carriage, and the rollers may act as supporting rollers. Additional receiving rollers may be mounted on a bottom portion of the carriage, adjacent supporting rollers, and engage the bottom plate of the casing.

### BACKGROUND OF THE INVENTION

Image-reading devices, such as color scanners, move an optical unit, which includes a light source and a photoelectric conversion device, a lens that guides light from the light source that is reflected from a document being scanned to the photoelectric conversion device, and reflective mirrors and other optical elements, along the document in order to acquire image data from the document. The optical unit is mounted in a carriage that is coupled to a portion of a timing belt or other drive belt that moves back and forth according to the rotation output of a drive motor so that the carriage moves back and forth with the portion of drive belt with which it is coupled. A guide rod fixed to the carriage extends in the direction of back and forth movement, which is termed the length direction of the carriage, to guide the back and forth movement of the carriage.

The proven use of such image-reading devices with personal computers and the increased use of personal computers has increased the demand for such image-reading devices in the home. However, there is often little space for personal computers and peripheral equipment, such as color scanners, in the home. A color scanner is not continuously used with personal computers and therefore must be able to be conveniently stored, even though a color scanner designed for scanning common documents, such as documents on A4 paper, must be relatively large in two dimensions. Therefore, thinner scanners, as well as lighter-weight scanners, are demanded that enable vertical storage in a small storage area.

The placement of the drive mechanism in conventional scanners often imposes a barrier to achieving a thinner configuration, as follows. In many conventional scanners, the guide rod is positioned substantially at the center portion of the carriage. Therefore, the guided portion that is coupled to this guide rod is positioned in a portion of the carriage that is separated from the optical unit by being placed in the lower portion of the carriage. Because the drive belt is preferably positioned in the vicinity of the guide rod in order to provide stability to the optical unit, the drive belt is also positioned in the lower portion of the carriage. Additionally, a portion of the drive motor and related components for moving a portion of the drive belt back and forth protrude at the lower portion of the carriage due to the positioning required by the drive belt. Therefore, a space for the guided portion, drive belt, and other components is required in the lower portion of the scanner casing, which results in a thicker casing being necessary than is desired.

### BRIEF SUMMARY OF THE INVENTION

The present invention relates to a carriage guide structure for an image-reading device that acquires image data from a document by scanning the document by moving an optical unit mounted in the carriage along the document. The carriage guide structure of the present invention reliably guides the movement of the carriage and allows the image-reading device to be very thin.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 shows an exploded perspective view of an image-reading device that includes a carriage guide structure of Embodiment 1 of the present invention;

FIG. 2 shows a cross-sectional view of the assembled image-reading device taken along the line A-A of FIG. 1;

FIG. 3 shows an exploded perspective view of an image-reading device that includes a carriage guide structure of Embodiment 2 of the present invention;

FIG. 4 shows a cross-sectional view of the assembled image-reading device taken along the line B-B of FIG. 3;

FIG. 5 shows an exploded perspective view of an image-reading device that includes a carriage guide structure of Embodiment 3 of the present invention;

FIG. 6 shows a cross-sectional view of the assembled image-reading device taken along the line C-C of FIG. 5;

FIG. 7 shows an exploded perspective view of an image-reading device that includes a carriage guide structure of Embodiment 4 of the present invention;

FIG. 8 shows a cross-sectional view of the assembled image-reading device taken along the line D-D of FIG. 7;

FIG. 9 shows an exploded perspective view of an image-reading device that includes a carriage guide structure of Embodiment 5 of the present invention; and

FIG. 10 shows a cross-sectional view of the assembled image-reading device taken along the line E-E of FIG. 9.

### DETAILED DESCRIPTION OF THE INVENTION

Five preferred embodiments of the carriage guide structure for an image-reading device of the present invention will now be individually described with reference to the attached drawings.

### Embodiment 1

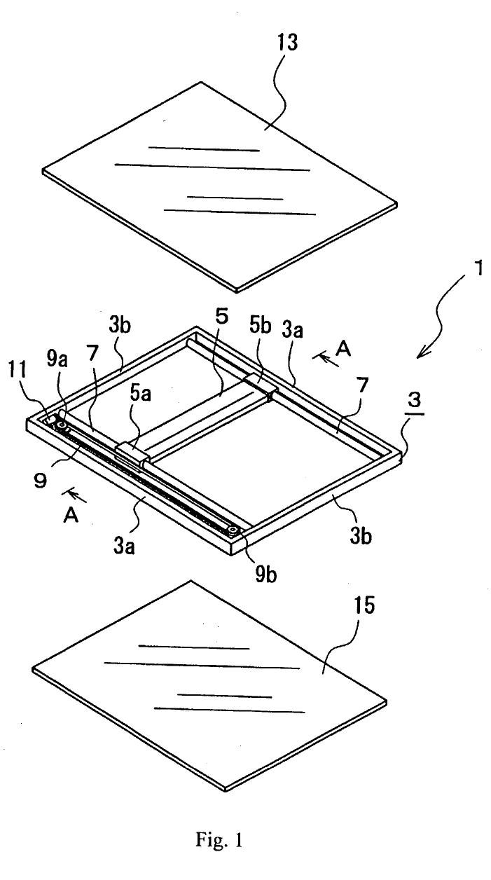

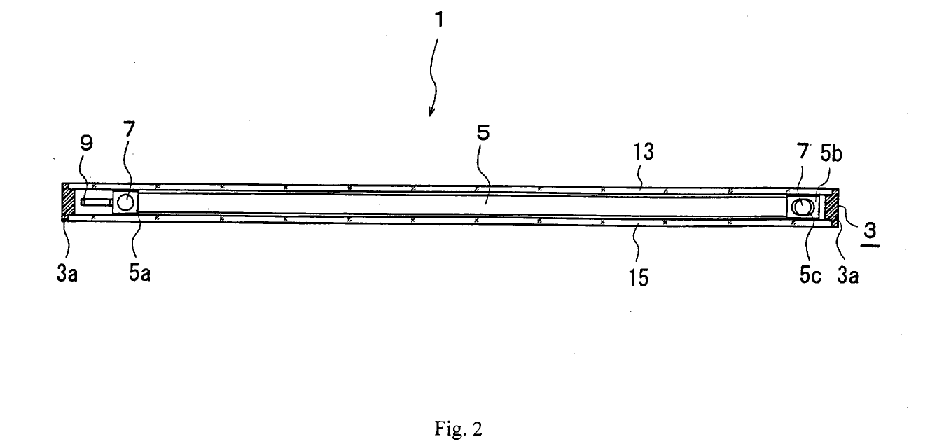

FIGS. 1 and 2 show Embodiment 1 of the carriage guide structure for an image-reading device of the present invention. FIG. 1 shows an exploded perspective view of the image-reading device, and FIG. 2 shows a cross-sectional view of the assembled image-reading device taken along the line A-A of FIG. 1. As shown in FIG. 1, the image-reading device 1 includes a carriage 5 that is housed inside a casing 3 made of plastic (i.e., synthetic resin) and of substantially a rectangular shape. The carriage 5 moves freely along the length direction of the rectangle. An optical unit that includes a light source, a photoelectric conversion device, as well as lenses, mirrors, and other components for directing light from the light source to a scanned document and directing light reflected from the scanned document to the photoelectric conversion device, not shown in the figures, are carried by the carriage 5. The optical unit may be integrated on the carriage to achieve compactness. Image data is sequentially acquired from the document by moving the carriage 5 to change the position that light is irradiated onto a document and the position of the components of the optical unit that receive reflected light from the document.

In order to guide the movement of this carriage 5, a pair of guide rods 7, 7 are positioned in the vicinity of each of the two longer wall portions 3a, 3a along the length direction of the casing 3. The end portions of both of these guide rods 7, 7 are supported by the two shorter wall portions 3b, 3b of the casing 3. Guided portions 5a and 5b are positioned on the side portions of carriage 5 and include guide holes for receiving the guide rods 7, 7 to provide for a sliding movement of the carriage 5 along the guide rods 7, 7.

As shown in FIG. 2, one guide hole 5c, which is formed in guide portion 5b, is elongated so that play is provided for an inserted guide rod 7. That allows for dimensional errors in the direction that is termed the width direction of the carriage, orthogonal to the length direction of movement of the carriage 5.

On the other side of the carriage 5, a drive belt 9 is positioned along the longer wall portion 3a between the guided portion 5a and the longer wall portion 3a of the casing 3. This drive belt 9 is suspended from the driving side pulley 9a to the driven side pulley 9b and is supported in a freely rotating manner in the vicinity of the shorter wall portion 3b. Output rotation from the drive motor 11 is transmitted to the driving side pulley 9a by a suitable transmission system, and a portion of the drive belt 9 moves back and forth according to the rotating direction of the drive motor 11. The guided portion 5a is fixed at a suitable location on the drive belt 9.

A platen glass 13, where a document to be scanned is placed, is attached to the upper portion of the casing 3. A bottom plate 15 made of glass is attached to the lower portion of casing 3. Glass is used for the bottom plate in that it is less subject to wear than is plastic.

In the carriage guide structure of Embodiment 1 of the present invention, when the drive motor 11 rotates, the portion of the drive belt 9 to which guided portion 5a is fixed moves back and forth according to the rotating direction of the drive belt 9. Because the carriage 5 is fixed through guided portion 5a to the drive belt 9, the carriage 5 moves while being guided by the guide rods 7,7 with the movement of the drive belt 9. The optical unit on the carriage 5 scans the document by the movement of the carriage, and image data of the document is acquired.

The thickness of the image-reading device 1 provided with the carriage guide structure of Embodiment 1 of the present invention is determined by the height of the carriage 5, the thickness of the platen glass 13, and the thickness of the bottom glass plate 15, and, as shown in FIG. 2, can be made extremely thin. That is because components, such as the guided portions, are positioned on the sides of the carriage rather than protruding from the lower portion of the carriage.

The strength of the casing may be reduced if the walls and other portions of the casing are not formed with sufficient thickness when the casing is molded of plastic. However, the strength of the casing may be increased, while only very slightly increasing the thickness of the image-reading device 1, by increasing the thickness of the bottom glass plate 15.

### Embodiment 2

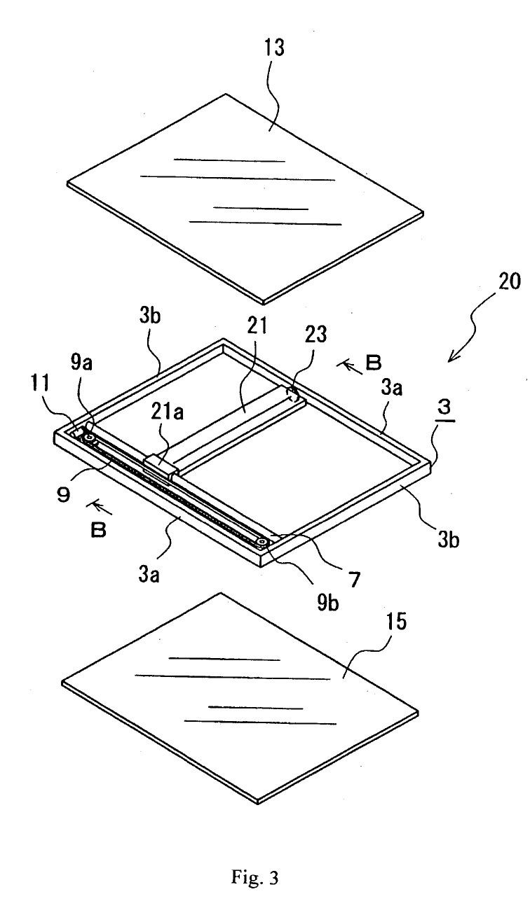

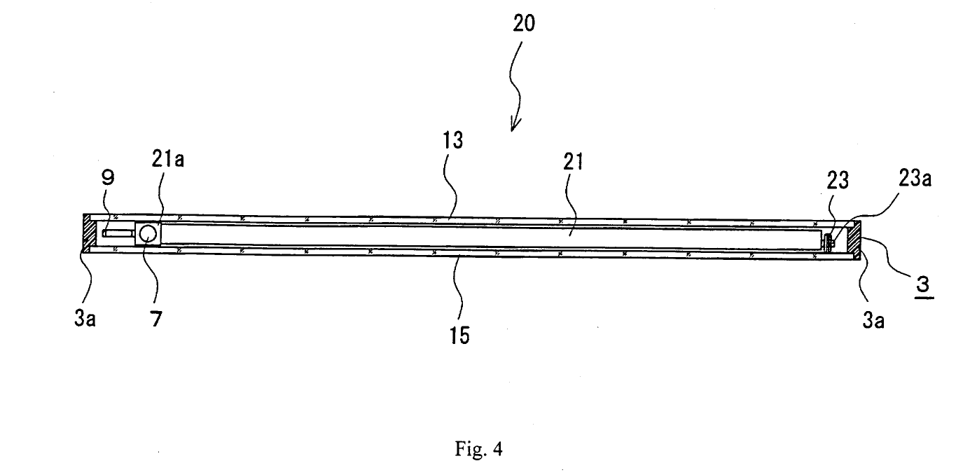

FIGS. 3 and 4 show Embodiment 2 of the carriage guide structure for an image-reading device of the present invention. FIG. 3 shows an exploded perspective view of the image-reading device, and FIG. 4 shows a cross-sectional view of the assembled image-reading device taken along the line B-B of FIG. 3. In Embodiment 2 of the present invention, the same reference symbols are used for components that are the same as in Embodiment 1 of the present invention.

As shown in FIG. 3, in the carriage guide structure for an image-reading device 20 of Embodiment 2, a roller 23 serves in place of the guided portion 5b to guide the carriage. As shown in FIG. 4, in Embodiment 2, a supporting axle 23a is placed on the side of the carriage 21, and the roller 23 is rotatably fitted on the supporting axle 23a, replacing the guide rod 7 and guided portion 5b of Embodiment 1. The roller 23 contacts the upper surface of the bottom plate 15 so as to support that side portion of the carriage 21, as shown in FIG. 4.

As in Embodiment 1, in Embodiment 2 the carriage 21 moves back and forth according to the back and forth movement of the portion of the guide belt 9 to which the carriage 21 is connected by rotation of the drive motor 11. Here, the carriage 21 is guided by the guided portion 21a formed on one side, which slides along the guide rod 7, and by the roller 23 on the other side, which rolls on the bottom plate 15. Because the bottom plate 15 is formed of glass, the surface is smooth, and the roller 23 can be moved in a smooth fashion. As a result, the movement of the carriage 21 is also smooth.

In Embodiment 2, the surface of the guide rod may be plated, with chrome plating for example, to make the movement of the carriage smoother, resulting in potentially higher production costs. However, by supporting one side of the carriage with a roller, the guide rod on that side can be omitted, thereby reducing production costs.

The thickness of the image-reading device 20 provided with the carriage guide structure related to Embodiment 2 is determined by the height of the carriage 21, the thickness of the platen glass 13, and the thickness of the bottom plate 15, and as shown in FIG. 4, in the same manner as the image-reading device 1 related to Embodiment 1, it can be made extremely thin.

### Embodiment 3

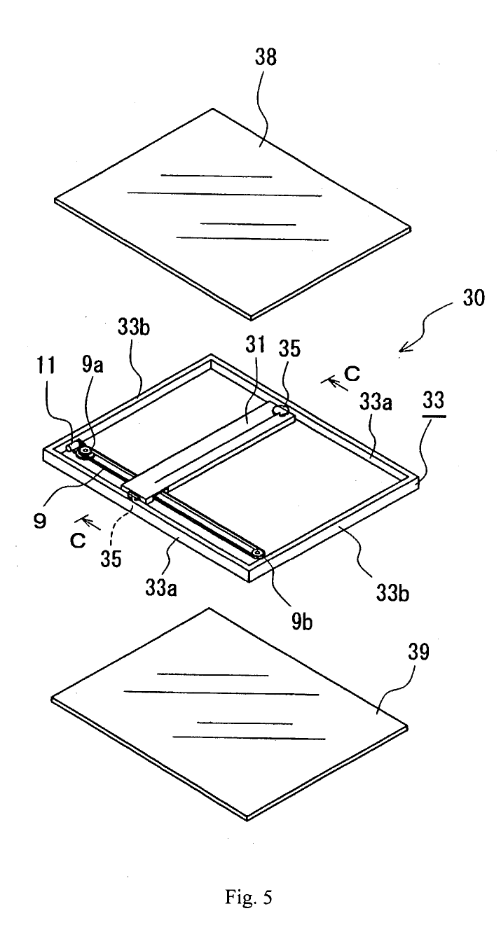

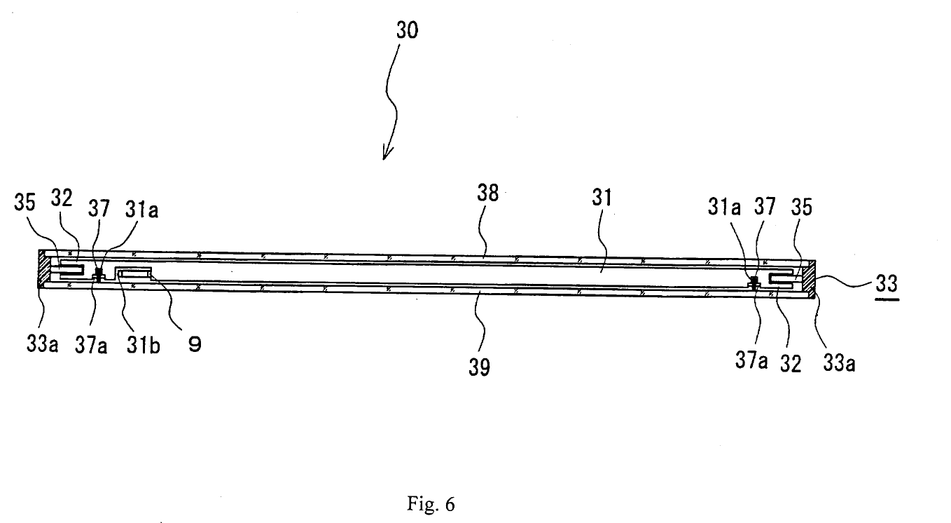

FIGS. 5 and 6 show Embodiment 3 of the carriage guide structure for an image-reading device of the present invention. FIG. 5 shows an exploded perspective view of the image-reading device, and FIG. 6 shows a cross-sectional view of the assembled image-reading device taken along the line C-C of FIG. 5. In Embodiment 3 of the present invention, the same reference symbols are used for components that are the same as in Embodiment 1 of the present invention.

As shown in FIGS. 5 and 6, in the carriage guide structure for an image-reading device 30 of Embodiment 3, the side surfaces of the carriage 31 are positioned in the vicinity of the longer wall portions 33a, 33a of the casing 33. Additionally, a supporting roller 35 is supported in a freely rotating manner on each of the side surfaces of the carriage 31 with the perpendicular direction serving as an axis of rotation, and the outer circumference surfaces of the supporting rollers 35, 35 are configured so as to make contact with the inner surface of the longer wall portions 33a, 33a. As shown in FIG. 6, the supporting rollers 35, 35 are housed in recesses 32, 32 formed in the opposite side surfaces of the carriage 31 and are supported so that a portion of each supporting roller 35 protrudes from a side surface of the carriage 31.

As shown in FIG. 6, on the inner side of the supporting rollers 35, 35 and on the bottom surface of the side portion of the carriage 31, receiving rollers 37, 37 are supported in a freely rotating manner by axles 37a, 37a set in the width direction so that the receiving rollers can roll in the length direction as the carriage 31 moves in the length direction. The axles 37a, 37a are supported and suspended across recesses 31a, 31a formed on the bottom portion of the carriage 31 so that a portion of each receiving roller 37, 37 protrudes from the lower surface of the carriage 31. As shown in FIG. 6, a recess 31b is formed on the bottom portion of one side of the carriage 31, and the drive belt 9 suspended across along the length direction of the casing 33 is positioned inside the recess 31b. Inside the recess 31b, the carriage 31 is directly fixed to a suitable position on the drive belt 9.

Additionally, as shown in FIG. 5, a platen glass 38 is attached to the upper portion of the casing 33, and a bottom glass plate 39 is attached to the lower portion of the casing 33.

The carriage guide structure related to Embodiment 3 of the present invention is configured such that the movement of the carriage 31 is guided by the supporting rollers 35, 35 which roll on the inner surfaces of the longer wall portions 33a, 33a of the casing 33, and by the receiving the rollers 37, 37 which roll on the bottom glass plate 39. If the image-reading device 30 is configured so that the receiving rollers 37, 37 are biased downwardly against the bottom glass plate 39 by biasing structures so that the receiving rollers 37, 37 protrude from the bottom surface of the carriage 31, then a reaction force acts on the carriage and tends to press the carriage 31 against the platen glass 38. In that case, the light source (not shown) on the carriage 31 may come very near a document that is resting on the platen glass 38 so as to be scanned (i.e., have its image read).

As shown in FIG. 6, in Embodiment 3 of the present invention, the thickness of the image-reading device 30 provided with the carriage guide structure related to Embodiment 3 of the present invention is determined by the height of the carriage 31 with the receiving rollers 37 protruding from the bottom surface of the carriage 31, the thickness of the platen glass 38, and the thickness of the bottom glass plate 39, and can be made extremely thin.

In Embodiment 3 of the present invention, the carriage 31 is supported by receiving rollers 37, 37 on both sides of the carriage 31, and the receiving rollers 37,37 are guided by the supporting rollers 35, 35 that are in contact with the inner surfaces of the side walls of the casing. As a result, the carriage is supported on its side surfaces by forces directed in a direction orthogonal to the direction of movement of the carriage 31. Because the thickness of the casing is sufficient if the thickness is adequate for housing the carriage, the casing can be made thinner, and because a guide rod is not required, production costs can be reduced and a less expensive image-reading device can be provided.

In Embodiment 3 of the present invention, receiving rollers 37, 37 are provided for rolling on the bottom glass plate 39. However, by forming structures, such as grooves in the longer wall portions 33a, 33a that act as guide rail portions for guiding the supporting rollers 35, 35 the receiving rollers 37, 37 may be omitted because the carriage 31 is supported by the supporting rollers 35, 35. Alternatively, by pressing the supporting rollers 35, 35 on the wall portion so that the supporting rollers fully support the carriage 31, the receiving rollers 37, 37 are again not required because the carriage 31 receives force in the width direction thereof to support it in a stable manner as it rolls.

When supporting the carriage 31 with the supporting rollers 35, 35 on the side portions of the carriage 31 by applying force in a direction orthogonal to the direction of movement of the carriage, a relatively high degree of precision in the dimensions related to the positional relationship between the carriage and the inner surfaces of the side walls is required. However, by providing receiving rollers 37, 37 support is not left only to the supporting rollers 35, 35 and the dimensional tolerances are increased; therefore, component manufacturing costs can be reduced and costs of producing an image-reading device controlled.

### Embodiment 4

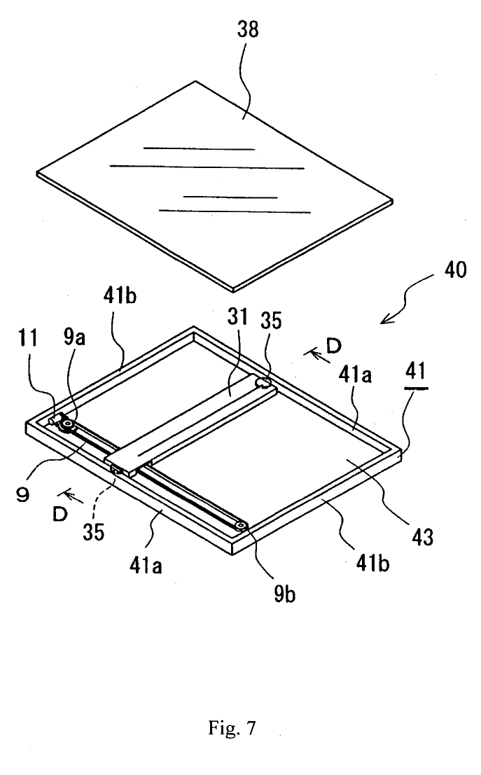

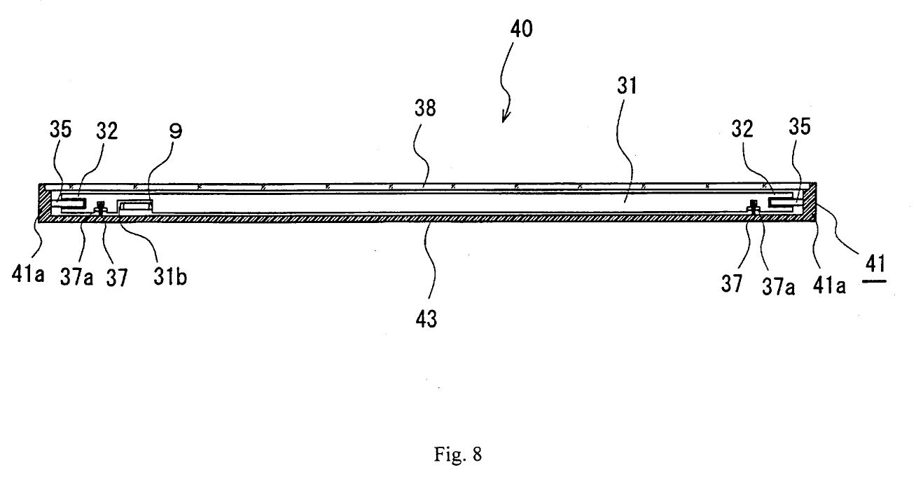

FIGS. 7 and 8 show Embodiment 4 of the carriage guide structure for an image-reading device of the present invention. FIG. 7 shows an exploded perspective view of the image-reading device, and FIG. 8 shows a cross-sectional view of the assembled image-reading device taken along the line D-D of FIG. 7. In Embodiment 4 of the present invention, the same reference symbols are used for components that are the same as in Embodiment 1 of the present invention.

As shown in FIG. 7, in the carriage guide structure for an image-reading device 40 related to Embodiment 4, the image-reading device 40 includes a casing 41 having a structure differing from the casing 33 of the image-reading device 30 related to Embodiment 3, but the other components are the same as those of Embodiment 3 of the present invention discussed previously. The casing 41 includes longer wall portions 41a, 41a, shorter wall portions 41b, 41b, and a bottom plate 43 made of one piece of plastic.

In the same manner as in Embodiment 3 of the present invention, in Embodiment 4 of the present invention, the movement of the carriage 31 is guided by the supporting rollers 35, 35 which roll on the inner side surface of the longer wall portions 41a, 41a of the casing 41, and by the receiving rollers 37, 37 which roll on the surface of the bottom plate 43. In order to allow the receiving rollers 37, 37 to roll smoothly on the bottom plate 43, the surface areas of the bottom plate 43 that are in contact with the rolling areas of the receiving rollers 37, 37 are preferably smooth. In this embodiment, the bottom plate 43 is made of plastic.

### Embodiment 5

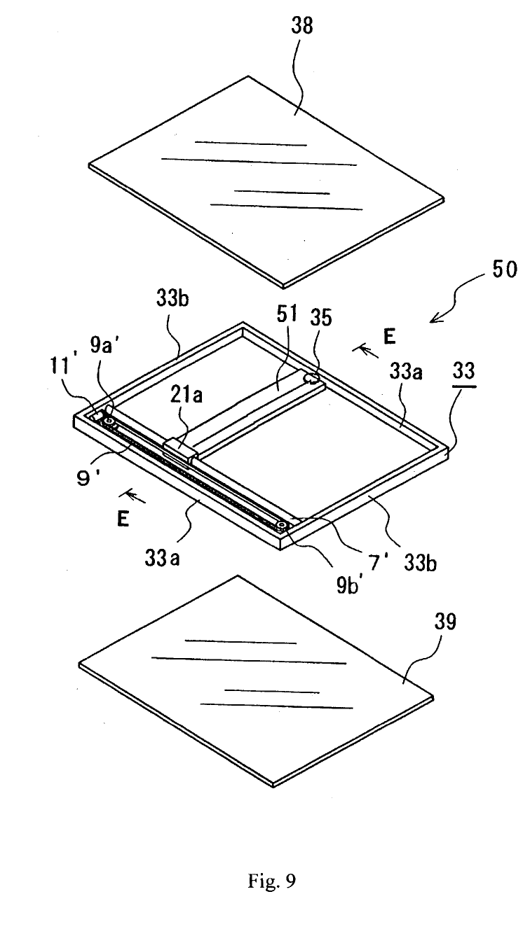

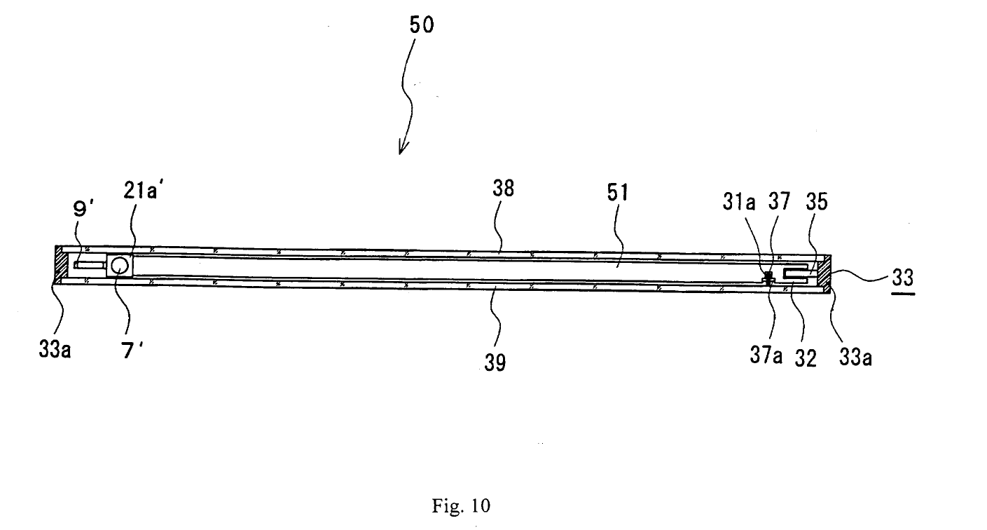

FIG. 9 shows an exploded perspective view of an image-reading device 50 that includes a carriage guide structure for a carriage 51 according to Embodiment 5 of the present invention, and FIG. 10 shows a cross-sectional view of the assembled image-reading device 50 taken along the line E-E of FIG. 9. Embodiment 5 is essentially formed of the left-side guide structure shown in FIGS. 3 and 4 (Embodiment 2) and the right-side guide structure shown in FIGS. 5 and 6 (Embodiment 3). In FIGS. 9 and 10, primed reference symbols are used for components that are identical to those shown with the same number in FIGS. 3 and 4, and unprimed reference symbols are used for components that are identical to those shown with the same number in FIGS. 5 and 6. Further explanation of these components will not be given. Also, because the operation of the drive mechanism at the left side of the image-reading device 50, as shown in FIG. 9, is essentially the same as that described previously with regard to Embodiment 2 of the present invention, further description of the operation of this embodiment will not be given.

The invention being thus described, it will be obvious that the same may be varied in many ways. For example, variations of using supporting rollers alone with or without receiving rollers, as described with regard to Embodiment 3 above, may be used on only one side of a carriage while a different arrangement may be used on the other side of the carriage, for example, an arrangement using a guide rod as in Embodiments 1, 2, and 5 of the present invention or an arrangement using a side roller as in Embodiment 2 of the present invention. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. A carriage guide structure for use in an image-reading device that includes an optical unit, the carriage guide structure comprising:
a carriage for supporting the optical unit, the carriage including first and second side portions that are on opposite sides of the carriage;
a casing that houses the carriage so that the carriage extends across the casing in a width direction with the first and second side portions being perpendicular to the width direction of the casing;
a guide rod, mounted within the casing, that extends in a length direction that is perpendicular to the width direction and parallel to the first and second side portions;
a bottom plate of the casing that extends in a plane in the length and width directions;
a guided portion that is positioned on the first side portion of the carriage and that slidably engages the guide rod to guide the carriage in the length direction for movement relative to the casing; and
a first roller that is supported on the second side portion of the carriage so that the first roller is freely rotatable in order to roll in the length direction on a surface of the casing so that the carriage is movable to scan a document when used in an image-reading device.

2. The carriage guide structure of claim 1, wherein the surface of the casing on which the first roller rolls is a surface of the bottom plate.

3. The carriage guide structure of claim 1, wherein:
the casing includes a side wall that extends perpendicular to the bottom plate and in the length direction;
the side wall includes an inner surface that faces the second side portion of the carriage; and
the first roller is supported in a freely rotatable manner to roll on the inner surface of the side wall of the casing.

4. The carriage guide structure of claim 1, further comprising:
a second roller on the bottom portion of the carriage near the first roller; wherein
the carriage includes a bottom portion,
the casing includes a bottom plate that extends in a plane in the length and width directions, and
the second roller is supported on the bottom portion of the carriage to be freely rotatable to roll on the bottom plate in the length direction.

5. The carriage guide structure of claim 3, and further comprising:
a second roller on the bottom portion of the carriage near the first roller; wherein
the carriage includes a bottom portion;
the casing includes a bottom plate that extends in a plane in the length and width directions; and
the second roller is supported on the bottom portion of the carriage to be freely rotatable to roll on the bottom plate in the length direction.

6. The carriage guide structure of claim 1, wherein the bottom plate is made of glass.

7. The carriage guide structure of claim 2, wherein the bottom plate is made of glass.

8. The carriage guide structure of claim 3, wherein the bottom plate is made of glass.

9. The carriage guide structure of claim 4, wherein the bottom plate is made of glass.

10. The carriage guide structure of claim 5, wherein the bottom plate is made of glass.

11. A carriage guide structure for use in an image-reading device that includes an optical unit, the carriage guide structure comprising:
a carriage for supporting the optical unit, the carriage including first and second side portions that are on opposite sides of the carriage; and
a casing that houses the carriage so that the carriage extends across the casing in a width direction with the first and second side portions being perpendicular to the width direction of the casing and extending in a length direction of the casing; wherein
the casing includes first and second side walls that are on opposite sides of the casing and that are parallel to and adjacent the first and second side portions of the carriage,
the first side wall includes a first inner surface that faces the first side portion of the carriage and the second side wall includes a second inner surface that faces the second side portion of the carriage,
a first roller is supported in a freely rotatable manner on the first side portion of the carriage to roll in the length direction on the first inner surface of the first side wall, and
a second roller is supported in a freely rotatable manner on the second side portion of the carriage to roll in the length direction on the second inner surface of the second side wall so that the carriage is movable to scan a document when used in an image-reading device.

12. The carriage guide structure of claim 11, and further comprising:
a third roller on the bottom portion of the carriage near the first roller; wherein
the carriage includes a bottom portion,
the casing includes a bottom plate that extends in a plane in the length and width directions, and
the third roller is supported on the bottom portion of the carriage to be freely rotatable to roll on the bottom plate in the length direction.

13. The carriage guide structure of claim 12, and further comprising:
a fourth roller on the bottom portion of the carriage near the second roller; wherein
the fourth roller is supported on the bottom portion of the carriage to be freely rotatable to roll on the bottom plate in the length direction.

14 The carriage guide structure of claim 11, wherein the bottom plate is made of glass.

15. The carriage guide structure of claim 12, wherein the bottom plate is made of glass.

16. The carriage guide structure of claim 13, wherein the bottom plate is made of glass.
